(19) United States
(12) Patent Application Publication
(10) Pub. No.: US 2008/0298877 A1
(43) Pub. Date: Dec. 4, 2008

(54) HOUSING AND MOVEMENT CONTROL SYSTEM FOR COSMETIC CONTAINERS

(75) Inventor: David Prague, Ringoes, NJ (US)

Correspondence Address: OBLON, SPIVAK, MCCLELLAND MAIER & NEUSTADT, P.C., 1940 DUKE STREET, ALEXANDRIA, VA, 22314, US

(73) Assignee: L'Oreal, Paris (FR)

(21) Appl. No.: 11/756,111

(22) Filed: May 31, 2007

(51) Int. Cl. B43K 21/00; B43K 21/02

(52) U.S. Cl. 401/78; 401/55

(57) ABSTRACT

One or more examples of the invention include a housing and one or more containers configured to be received in the housing. Each container includes a projection formed on an outside surface configured to engage with a groove formed in an interior portion of the housing such that the projection of the container enters the groove of the housing when the container is mounted in said housing to help guide movement of the at least one container within the housing.

### BACKGROUND OF THE INVENTION

1. Field of the Invention

This invention relates to a housing and movement control system for containers having cosmetic products stored therein. According to an example, the housing includes one or more grooves that form a part of a movement control system and are configured to help secure and guide the movement of the containers with respect to the housing.

2. Description of the Related Art

Storage containers for cosmetics or the like are known that have a container that holds a plurality of cosmetic products. For example U.S. Pat. No. 4,562,923 discloses a cosmetic case that holds one or more cosmetic pencils in a hollow container having a plurality of openings on one side to receive the pencils. The pencils are held by a holding body which is slidably received in the accommodating space of the cosmetic container. When a user would like to pick a pencil for use, the lock knob is operated to release the elastic projection from the recess and the spring urges the holding body forward to project the handheld portion of the cosmetic pencils from the opening.

However, with the above-discussed device, there is no arrangement to control individual movement of the pencils. This device merely provides a sliding container for holding and releasing all of the multiple cosmetic products. Therefore, the cosmetic device in the related art does not provide for a feature for a guidance system that controls the movement of the individual cosmetic containers in a housing.

A cosmetic case similar to the case disclosed in U.S. Pat. No. 4,858,765 includes a lipstick case holder and a lipstick encasing case adapted to receive the case holder. The encasing case includes apertures to show a tip portion of the lipstick cases contained therein. However, a diameter of the aperture of the encasing case is smaller than the diameter of the lipstick cases. Therefore, the lipstick cases are not able to slide through the aperture. Accordingly, such a device does not provide for sliding movement of the lipstick cases into and out of the encasing case. Further, the encasing case requires a substantial amount of space to merely hold the lipstick cases.

### SUMMARY OF THE INVENTION

According to an aspect of the invention, it has been recognized that prior cosmetic devices suffer from one or more disadvantages including: less than satisfactory storage devices for individual cosmetic containers and/or storage devices for cosmetic containers that are cumbersome or unsightly.

The present invention relates to cosmetic device that includes a housing and movement control system for cosmetic containers. According to an example, the device includes a housing that is suitable for holding a plurality of cosmetic containers that are slidably engaged with the housing. The invention provides a cosmetic device that has one or more individual containers of product and must allow for these containers to be accessible and provide good utility to the consumer.

According to one or more examples, the apparatus of the invention allows a user to slide the containers with respect to the housing in a secure manner and to provide control for movement of the containers in the housing.

According to an example of the invention, when these containers are placed in a housing, the consumer can push or pull the container to expose it for use.

According to an example, the movement control system provides a desirable resistance to the user when sliding the containers within the housing and provides confidence to a user that the sliding containers are secured during sliding and also secured in an open or closed position.

In one example, the containers include a projection that is received in a groove formed in the housing to provide a secure and controlled sliding of the containers with respect to the housing. That is, the projection and corresponding groove are configured such that mechanical resistance developed by the projection within the groove is substantially constant as the projection is moved from a first end to a second end of the groove. With such an arrangement, the projection sliding in the groove can provide a secure non-loose feeling to the user during sliding of the container up and down in the housing.

In another example, in the fully extended position for the container, the groove includes a stopping feature to secure the projection and prevent further sliding movement of the container with respect to the housing.

Embodiments of the present invention can include, for example, a movement control system having a groove that is at least substantially non-visible by the user. As an example, the area of contact of the projection and groove can be formed in an interior portion of the housing. Accordingly, it is difficult for a user to see much of the movement control system, which provides an aesthetically pleasing cosmetic container.

By way of example, a removable securing device can be provided for securing the containers within the housing to prevent the containers from releasing from the housing when not desired by the user.

According to a further improvement, the width of the groove can change in order to increase or decrease the amount of contact between the projection and groove. In this way, resistance generated between the projection and the groove changes and alters the feeling to the user during sliding of the container. An example of the invention provides a set of bumps situated in close proximity to retain the projection there between and aid in securing the container in the fully retracted or fully extended position. In this way, one or more examples of the invention control the force it takes to slide the containers in the housing.

A further example of the invention provides an audible click to indicate the projection has been secured between a set of bumps.

An example of the invention provides a feature to prevent the containers from being twisted in the housing if the consumer applies torque to open or close container.

One or more embodiments of the invention allows for consumer customization of the cosmetic device by ease of refilling or swapping the containers of cosmetic product, for example from a lipstick to a mascara. As such, the device according to the invention may advantageously be used for packaging of a cosmetic or dermatological product, in the form of a liquid, soft, semi-soft, or hard product.

As should be apparent, the invention can provide a number of advantageous features and benefits. It is to be understood that in practicing the invention, an embodiment can be constructed to include one or more features or benefits of embodiments disclosed herein, but not others. Accordingly, it is to be understood that the preferred embodiments discussed herein are provided as examples and are not be construed as limiting, particularly since embodiments can be formed to practice the invention that do not include each of the features of the disclosed examples.

### BRIEF DESCRIPTION OF THE DRAWINGS

The invention will be better understood from reading the description which follows and from examining the accompanying figures. These are provided solely as non-limiting examples of the invention. In the drawings:

FIG. 1 is a schematic showing a housing for holding cosmetic containers according to an example of the invention;

FIG. 2 is a schematic showing a cosmetic housing according to an example of the invention;

FIG. 3 is a cosmetic container having a movement control device according to an example of the invention;

FIG. 4 is a schematic showing a cosmetic container according to an example of the invention; and

FIG. 5 is a schematic showing a securing device for a bottom portion of the cosmetic device according to an example of the invention.

### DETAILED DESCRIPTION OF THE PREFERRED EMBODIMENTS

Reference will now be made in detail to the present preferred embodiments of the invention, examples of which are illustrated in the accompanying drawings. Wherever possible, the same reference characters will be used throughout the drawings to refer to the same or like parts.

As discussed earlier, during use of a compact, a sliding movement that is not controlled can feel loose and insecure to the user. Additionally, a movement control device that takes up a lot of space is not desirable.

Accordingly, the compact device preferably includes a movement control device that provides for sliding movement of cosmetic containers held by a housing to slide in a secure manner and lock in the fully extended or fully retracted positions. Further, the movement control device is not substantially visible to the user during normal use which provides an aesthetically pleasing device to the user.

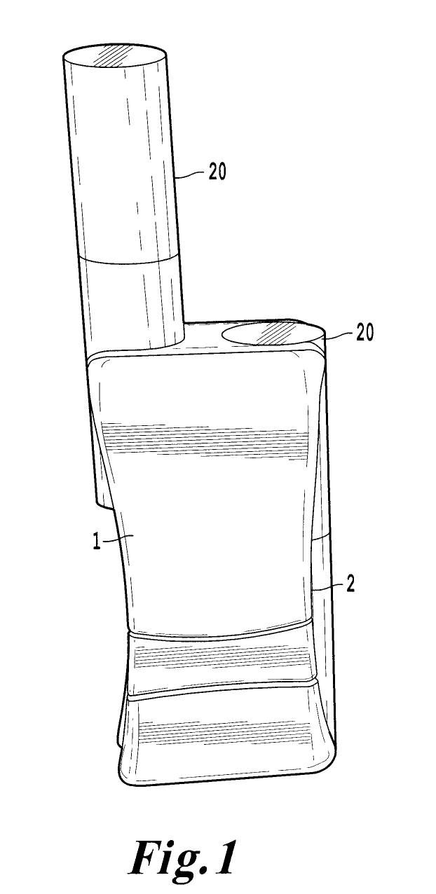

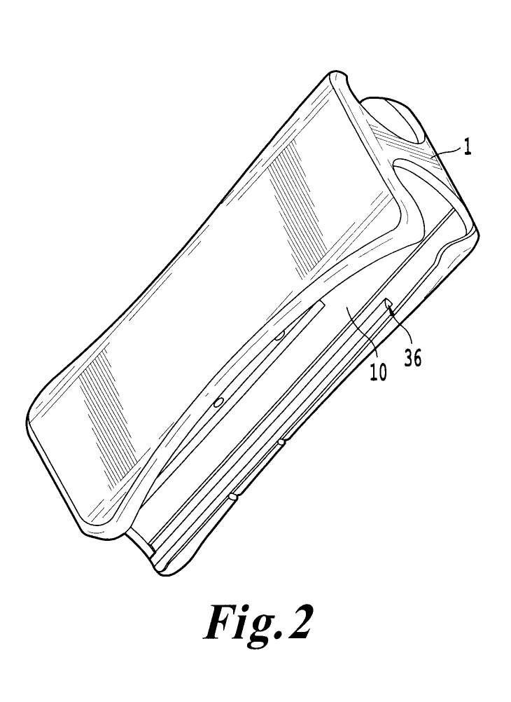

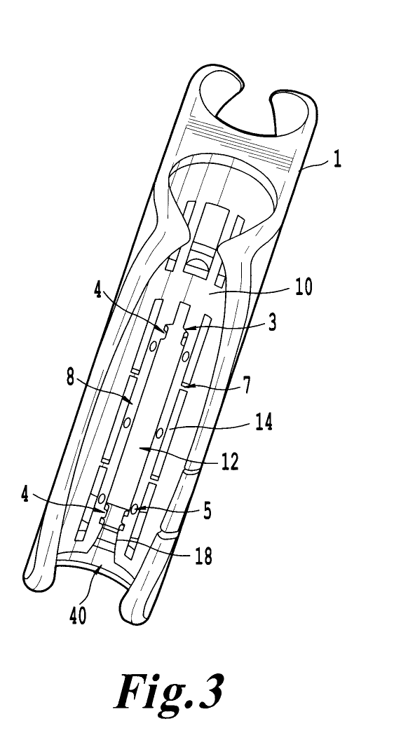

FIGS. 1 and 2 are schematics showing the cosmetic device according to an example of the invention. The housing 1 of the cosmetic device can be a generally rectangular device that can receive a plurality of cosmetic containers 20. The Figures show the housing 1 as having an outside wall with a tapered region 2 that tapers inwardly to form an area where the containers 20 are visible. According to an example, the tapered region 2 forms the narrowest region of the edges of the front face of the housing 1 and is located in about a center region of the housing 1. Conversely, as best shown in FIG. 3, the center area of the housing formed by the front and back surfaces of the housing 1 forms the widest area between the front and back surface as compared to the narrower area near the top and bottom of the housing 1.

Accordingly, it should be appreciated that due to design, aesthetic and/or other considerations, the housing 1 can be designed so that any amount of the containers 20 can be visible to the user. Providing a visible surface of the containers 20 can aid the user in identifying the product in the containers 20 as well as provide an area of the container 20 for the user to contact during sliding movement of the containers. In a further example, the housing 1 can be a shape to at least substantially hide the containers 20 when they are stored in the housing 1.

It is within the spirit and scope of the invention to have any number of containers 20 that can slide in the housing 1. For example, the housing 1 can be provided with three containers 20. Each of the containers 20 would be able to slide into the housing 1 with the help of guidance slots 36 to engage with a movement control device 10 formed in the housing 1. The containers 20 could then slide with respect to the housing 1 along the movement control device 10 as described in one or more examples of the invention set forth below.

Further, the containers 20 are shown in the Figures as a generally circular containers. However, examples of the invention can include containers having any desirable shape such as triangular, oval, square, rectangular, and the like. Further, it should be appreciated that the housing and/or cosmetic containers of the invention can be made of any known or later developed material such as plastic, metal or a metalized surface, which can be formed into a structure capable of holding the containers and/or containing a cosmetic product for a user. Additionally, the housing 1 can be made to have a reflective surface allowing the user to see themselves to aid in applying the cosmetic product. Even further, the containers 20 can have identifying markers on an outside surface to identify the product contained therein, for example, the containers 20 can be made of different colors from each other and/or from the housing 1.

When the cosmetic device is resting on a horizontal surface, the containers slide substantially vertically up and down in the housing 1. In other words, during sliding, relative movement of the containers 20 with respect to the housing 1 is vertical.

According to a preferred embodiment of the invention, the device may advantageously be used for packaging of a lip product, a skin product, or other type of make-up, cosmetic or dermatological product, in the form of a liquid, soft, semi-soft, or hard product and can be stored in a hollow interior portion of the containers 20. The product can be for example, a liquid, a gel, a cream, powder and can have the consistency of, for example, a solid or cake, pasty, semi-soft, or flowable product. For example, the containers 20 can contain eye liner, eye shadow, eye lash product, mascara, blush, lipstick, lip gloss, lip pencil, and the like. As such, according to one or more examples of the invention, a user can customize which cosmetic products are going to be carried in the housing 1 by picking the containers 20 storing the desired product. The invention provides an ease of refilling or swapping the containers of cosmetic product, for example from a lipstick to a mascara and therefore allows the consumer to customize the products held by the housing 1.

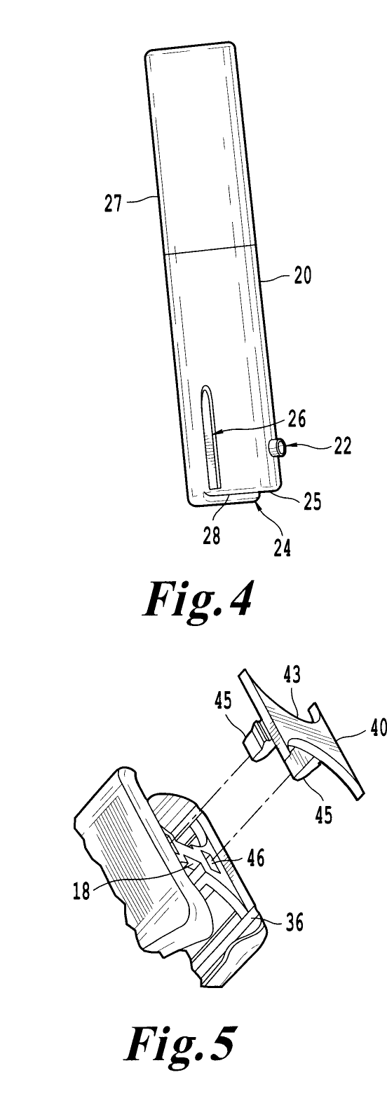

FIG. 3 is a side view of housing 1 including the movement control device 10 according to one or more examples of the invention that allows for a secure controlled sliding movement between the containers 20 and housing 1. By way of example, the control device 10 can include a groove 12 formed in the substantially longitudinal direction of the housing 1. The groove 12 can receive the projection 22 formed on the container 20, as best shown in FIG. 4. It should be appreciated that the groove 12 of the control device 10 can be any shape or size as long as it is able to receive the projection 22 of similar size and shape.

As shown in FIG. 3, the various features of the movement control device 10 are small enough to be contained within the confines of the housing 1. In this way the cosmetic device can be small and easy to use while also taking in to account, design, aesthetic and/or other considerations that are desirable to the user. Further, it should be appreciated that the control device 10 can be configured to be inserted into housing 1 or can be formed integrally with the housing 1 during manufacturing. The control device 10 can be formed as individual pieces depending on the number of containers held by the housing 1, or can be formed as one piece. Further, the portions of the control device 10 that contact the containers 20 can be any shape or size to complement the shape and size of the containers 20.

By way of example, the housing 1 can include one or more grooves 12 formed in an interior portion of the housing 1. Each of the containers 20 held by the housing 1 can include a projection 22 that is received in the groove 12. That is, when the containers 20 are loaded into the housing 1, they are loaded into the housing 1 through a bottom area of the housing 1 and slid into the interior portion of the housing 1. The projection 22 and corresponding groove 12 are configured to engage such that mechanical resistance developed by the projection 22 within the groove 12 is formed as the container 20 is moved in the housing 1. For example, as the container 20 is slide in the housing 1 from an extended position (the container 20 outside housing 1 in FIG. 1) to a retracted position (container 20 within housing 1 in FIG. 1) or vice-versa, resistance that is generated between the projection 22 and the groove 12 can provide a controlled and secure non-loose feeling to the user.

A wider portion 18 formed as the base of the groove 12 can be provided to make it easier to insert the projection 22 into the groove 12 when inserting the container 20 into the housing 1. As an example, the container shown in FIG. 4 includes a projection 22 formed on an outer surface near a bottom of the container 20. Therefore, the projection 22 can engage the groove 12 when the container 20 is within the housing 1 and is either in the fully extended position, fully retracted position, or any position in between. That is, when the container 20 is in the retracted position within housing 1, the projection 22 will be located at or near the bottom of the groove 12. When a container 20 is moved to an extended position, the projection 22 slides in the groove 12 and will end up at or near the other or top end of the groove 12. As such, the container 20 slides vertically within the housing 1 with a suitable resistance feel provided by the engagement of the projection 22 and groove 12. It should be appreciated that the projection 22 can be formed at any position on the outer surface of the container 20.

In an example, the groove 12 can be formed to have a substantially constant width in the area between the bumps 4. The width of the groove 12 can be formed to be at least slightly smaller than the width of the projection 22. Therefore, as the user slides the container 20 in the groove 12, a resistance is felt by the user created by the mechanical resistance formed between the projection 22 and groove 12. Due to the substantially constant width of the groove, the resistance felt by the user remains substantially the same. Further, because the width of the groove 12 is smaller than the projection 22, if the user stops sliding the container 20 in the housing 1, the container 20 will not continue to slide with respect to the housing 1 due to forces such as gravity, and the container 20 can remain in its current position. According to this example, the constant width of the groove 12 will provide a secure and controlled sliding of the container 20 and can provide a secure non-loose feeling to the user during extending and retracting of the container 20 in the housing 1.

In an example of the invention, a slit 14 can be located on each side of the groove 12. As shown in FIG. 3, the slits 14 are oriented substantially parallel to the groove 12 to form a track 8, which is the portion of the control device 10 that contacts the projection 22 as the projection 22 slides within groove 12. Due to the position of the slit 14, the track 8 can be made flexible. That is, providing the slits 14 next to the groove 12 can allow for the track 8 to move in a direction transverse to the longitudinal direction of the groove 12 and flex as the projection 22 slides in the groove 12. Because the track 8 is flexible, various or differing sizes of projections 22 can be accommodated in the groove 12. Further, the flexible track 8 can account for manufacturing tolerances of the various features of the movement control device 10 and therefore, a greater range of sizes and shapes can be used while ensuring the movement of the container 20 in the housing 1 has a consistent feel.

According to an example of the invention, one or more reinforcing ribs 7 can be formed in the slits 14 to provide structural support. For example, some containers 20 installed in the housing 1 that include a threaded closure like a lip gloss or mascara, generally require torque to be applied to the cap 27 when the cap 27 is opened or closed. Adding the reinforcing ribs 7 to the slits 14 can prevent the projection 22 from turning out of the groove 12 from the torque produced when the cap 27 is rotated open or closed. Accordingly, the ribs 7 can provide enough structural support to prevent the projection 22 from sliding out of the groove 12 while also allowing enough flexibility for the track 8 to accommodate projections 22 of differing sizes due to design consideration of various containers 20 and due to manufacturing tolerances.

According to a further example of the invention, the flex track 8 can include one or more raised portions 5 that can contact the container 20 when the container 20 is placed in the housing 1. The raised portions 5 can sit on the flex track 8 and can place a substantially constant pressure on the containers 20 as the containers 20 slide in the housing 1. In an example, as the container 20 is moved in the housing 1, the raised portions 5 formed on the track 8 will push the container 20 in a direction of the outside edge of the housing 1 holding in the container, for example in an area of the tapered area 2. In a further example of the invention, the raised portions 5 can also place a constant pressure on the container guiding protrusion 26 as they sit in the guidance slots 36. In this way, the outside edge of the container housing 20 is not required to maintain constant contact with the raised portions 5 and a smooth controlled feel can be provided to the user as the user slides the containers 20 in the housing 1.

The flexibility of the track 8 will allow the track 8 to be moved in a direction away from the containers 20 due to the contact of the containers 20 with the raised portions 5 but still maintain constant contact with the containers 20. It should be appreciated that the raised portions 5 can be provided along any contacting surface of the control device 10 and/or provided on the outer surface of the container 20. In accordance with this feature, the raised portions 5 can contact portions of the container 20, such as a side surface, in order to maintain a desirable amount of contact and pressure between those components. Further, providing the raised portions 5 can compensate for tolerance variations that can arise due to production molds and various other factors and can help maintain contact between the control device 10 and the container 20. As such, a controlled constant feel is provided to the user when the containers 20 are raised or lowered in the housing 1.

In an example as shown in FIG. 3, at a top end of the groove 12 can be formed a narrower portion 3 to prevent the projection 22 from sliding any further upward in the groove 12. Accordingly, the container 20 will not continue to slide up and out of the housing 1. As a further example, the groove 12 could also stop at an area of the narrower portion 3 which will act to stop further movement of the container 20. Accordingly, the container 20 and housing 1 will be in a locked position with respect to each other and the container 20 will be securely set in the fully extended position.

As a further example, a plurality of bumps 4 can be provided on one or more side walls of the track 8 that project into the area of the groove 12. The bumps 4 can be provided at a location before the end portion of the groove 12, for example, at a location just before the narrower portion 3. Further, bumps 4 can be provided at or near a bottom portion of the groove 12, for example near the wider portion 18. Providing bumps 4 at least in these locations allows the containers 20 to be secured in a fully extended position or a retracted position as shown in FIG. 1.

For example, when a user wishes to use the contents of container 20 held in housing 1, the container 20 can be slide in the upward direction until the projection 22 slides past the bumps 4 and comes to rest between the bumps 4 and narrower portion 3. The container 20 can not slide upwards any further due to the narrow portion 3 as discussed above. According to this feature, the interaction between the bumps 4, narrow portion 3 and the projection 22, a secure stopping position can be provided for the container 20 with respect to the housing 1. At this position, there is minimal or no overlap between the housing 1 and the cap 27 of the container 20. Accordingly, the stored cosmetic and/or other material in the container 20 can easily be removed without interference with other parts of the cosmetic device. In a preferred embodiment, when the container 20 is in a fully extended position, the cap 27 for the container 20 rests above a top surface of the housing 1 and can be opened to allow the user to use the product contained therein.

When the user wishes to slide the container 20 back into a storage position, the user can apply a force to slide the container 20 downwards until the projection 22 slides in between sets of bumps 4 formed on each side of the groove 12 at or near the bottom of the groove 12. That is, the projection 22 will come to rest in between the two bumps 4 formed on each side of the groove 12. In this position, the container 20 is in a fully retracted position for storage within the housing 1. Further sliding of the containers 20 downward and removing the containers 20 from the housing 1 for replacement will be discussed with respect to FIG. 5.

Therefore, when the containers 20 are in the extended or retracted positions and the projection 22 is engaged with the bumps 4, the user can place one or more fingers on any portion of the container 20, for example a side or bottom surface, and apply a force in a substantially longitudinal direction of the container 20 to overcome the contact provided between the projection 22 and bumps 4 and/or narrow portion 3 in order to slide the container 20 in a desired direction. Accordingly, the container 20 will not slide in the housing 1 by merely touching the container 20, and the container 20 can be safely and securely stored in the housing 1. Further, the user can feel the extended and retracted limits so that a stable and favorable feel of use can be obtained.

According to one or more examples of the invention, when the projection 22 engages the bumps 4 and/or narrow portion 3, an audible noise can be generated that can alert the user that the container 20 has been secured in an extended or retracted position. It should be appreciated that the bumps 4 can have any desirable shape or size and can be at any intermediate position between the fully extended and fully retracted positions in order to allow the container 20 to be secured in an intermediate position between the extended and retracted positions and to also provide the user with an audible noise at any position to indicate to the user a desired position of the container 20.

According to an example shown in FIG. 5, a securing device 40 can be secured to a bottom area of the movement control device 10. It should be appreciated that the securing device 40 can be secured to an outside bottom surface of the housing 1. One or more protrusions 45 can be formed on the securing device 40 that are configured to engage one or more protrusion receiving elements 46 formed in the movement control device 10 in order to removably secure the securing device 40 to a bottom area of the housing 1.

The securing device 40 can be removed to facilitate removal of a container 20 from the housing 1. When the container has been refilled, replaced, exchanged, or the like and slid back into the housing 1, the securing device 40 can be reattached and the containers 20 will be securely held within the housing 1. It should be appreciated that the protrusions 45 and protrusion receiving elements 46 could have any desirable shape or size. It should be appreciated that the connection between the securing device 40 and movement control device 10 or housing 1, can be in the form of a clasp or snap or similar structure in order to facilitate the connection there between. When connecting or removing the securing device 40, the user will have to provide enough force to sufficiently engage or disengage the protrusion receiving elements 46 with the protrusions 45 to sufficiently connect or disconnect the securing device 40.

It should be appreciated that an example of the invention provides for other ways to remove and replace the containers 20 from the housing 1. For example, the housing 1 can include a first container mounting side and a second container mounting side. A first container 20 can be mountable on the first container mounting side and a second container 20 can be mountable on a second container mounting side. In accordance with this example, the cosmetic device can be shifted between a first operational state in which the container 20 is movable relative to the housing 1 between an extended position and a retracted position and the container 20 is locked to the housing 1 such that the container 20 is not dislocated or separated from said housing, and a second operational state in which the container 20 is removable from the housing 1. It should further be appreciated that other methods of releasing the locking relationship between the containers 20 and the housing 1 are within the spirit and scope of the invention.

An example of the invention provides a securing device 40 that can be formed to have semicircular regions 43 to receive a portion of the container 20 as discussed in further detail below. The securing device 40 can extend along the length of the bottom of housing 1. It should be appreciated that the securing device 40 can extend along any length of the bottom of housing 1. When secured to the housing 1, the securing device 40 is substantially coplanar with a bottom surface of the housing 1.

As shown in FIG. 4, the bottom portion of the containers 20 can have portions with differing heights, for example, a lower portion 24 and an upper portion 25. Accordingly, as the containers 20 are placed in housing 1 and the securing device 40 is secured to the housing 1, the upper portion 25 can be positioned between the securing device 40 and the interior of the housing 1. As such, in this position, the upper portion would not be visible to the user when the container is in the retracted position. In this example, a ridge 28 formed by the lower portion 24 and upper portion 25 can be formed to match the curve of the semicircular region 43 of the securing device 40. Therefore, the lower portion 24 can be formed substantially coplanar with the bottom of housing 1 and also the bottom surface of securing device 40. Accordingly, when the cosmetic device is placed on a surface, such as a table, the bottom of the cosmetic device, formed by the bottom of the housing 1, the securing device 40 and the lower portion 24 of the containers 20 will be substantially coplanar to support the cosmetic device in the standing position. It should be appreciated that even when the containers 20 are not in the fully retracted position, the housing 1, with or without the securing device 40 in place, could support the cosmetic device in an upright position.

As best shown in FIGS. 4 and 5, a side wall area of the container 20, for example along a bottom portion thereof, can include at least one guiding protrusion 26. The at least one guiding protrusion 26 is configured to engage with a corresponding number of guidance slots 36 formed in the control device 10. In conjunction with the projection 22 being oriented to fit into wider portion 18, the orientation of the guiding protrusion 26 to fit within the guidance slots 36 can guide container 20 to an appropriate connection with the control device 10 so as to correctly orient the container 20 within housing 1 when a user is replacing a container 20 after refilling or changing the desired container 20 to be stored in the housing 1. Additionally, the interaction between the guiding protrusion 26 and the guidance slot 36 will prevent the container 20 from moving laterally in the housing 1 when the housing geometry does not sufficiently enclose the container 20.

The guiding protrusion 26 and guidance slots 36 can have any desirable shape, such as, a square, rectangle, triangle, and any desirable length such along the longitudinal direction of the container 20 in order to facilitate the proper orientation and connection between the container 20 and housing 1. It should be understood that the at least one guiding protrusion 26 and guidance slot 36 can be any type of structure capable of guiding and/or securely connecting the container 20 with the control device 10 and thus, the housing 1.

The guiding elements used to properly orient the container 20 with the housing 1 could also be in the form of a marking or other visible display aiding the user with securing the container 20 within housing 1. In this way, the container 20 can be connected to the housing 1 in an appropriate and desirable position to facilitate the reloading of the container 20 into the housing 1.

Obviously, numerous modifications and variations of the present invention are possible in light of the above teachings. It is therefore to be understood that within the scope of the appended claims, the invention may be practiced otherwise than as specifically described herein

It is to be understood that terms such as includes, having, has, etc. as used herein are used to mean “includes at least one,” unless otherwise specified. Similarly, references to higher numerical designations such as “includes two,” etc., are to be understood to mean “includes at least two” unless otherwise specified.

1. A device for containing a product, comprising:
a housing having at least one groove formed therein;
at least one container which is mountable within the housing; and
at least one projection formed on an outside surface of at least one container,
wherein the at least one projection is received in a respective groove of the housing upon mounting of the at least one container in the housing,
wherein the projection and groove align the container with respect to said housing such that said projection of said at least one container enters the groove of said housing when said container is mounted in said housing to help guide movement of the at least one container relative to the housing, and
wherein the housing includes a bottom portion having at least one aperture configured to receive the at least one container and a top portion having at least one aperture configured to allow at least a portion of the at least one container to extend therethrough.

2. The device according to claim 1, wherein the at least one groove is formed substantially parallel to a direction of movement of the container within the housing.

3. The device according to claim 1, wherein the at least one container includes a projection having a first diameter and the groove for receiving the projection has a second diameter smaller than the first diameter.

4. The device according to claim 3, wherein a width of the groove remains substantially constant along a length of the groove from a beginning portion near the bottom end of the housing to an end portion near the top portion of the housing to thereby maintain a constant resistance created between the projection and the groove as the container is slide within the housing.

5. The device according to claim 1, wherein the at least one aperture formed in the housing is substantially cylindrical and a corresponding container has a complementary shape to fit in the aperture.

6. The device according to claim 2, wherein the at least one groove is formed integrally with the housing.

7. The device according to claim 2, wherein the at least one groove is a part of a movement control device formed within the housing.

8. The device according to claim 7, further comprising slits formed in a portion of the movement control device, wherein the slits extend substantially parallel to the groove.

9. The device according to claim 8, wherein a track is formed between an area formed by the groove and slit, the track is configured to contact the projection as the projection slides within the groove.

10. The device according to claim 9, wherein the track is configured to flex in a direction substantially perpendicular to a longitudinal direction of the groove.

11. The device according to claim 7, wherein the movement control device further includes protrusions formed on a surface thereof configured to contact an outer surface of the container.

12. The device according to claim 7, wherein the movement control device includes at least one slot configured to receive a respective at least one guide protrusion formed on an outer surface of the container when the container is mounted on said housing to align said container with respect to said housing such that said guide protrusion engages said slot when said container is mounted on said housing.

13. The device according to claim 4, wherein a plurality of projection engaging devices are formed in an interior portion of the groove to engage the projection.

14. The device according to claim 13, wherein the projection engaging devices are a plurality of bumps formed on each side of the groove configured to allow the projection to slide there between.

15. The device according to claim 14, wherein a stopping portion is formed at a top portion of the groove to prevent the projection from further movement towards the top portion of the housing and prevent the at least one container from being discharged from the housing through the aperture formed at the top end.

16. The device according to claim 15, wherein the stopping portion is formed from bumps having a sufficient size to prevent the projection from moving past the bumps.

17. The device according to claim 15, wherein the stopping portion in formed from a sufficient narrowing of the groove to prevent the projection from sliding any further in the groove.

18. The device according to claim 17, wherein a bump is formed on each side of the groove at a position just before the narrowing to secure the projection in an area between the bumps and the narrowing portion and thereby secure the container in a fully extended position.

19. The device according to claim 15, wherein when the container is secured in the fully extended position, a cap formed on the container for providing access to contents of the container, is located outside of the housing.

20. The device according to claim 14, wherein a portion of the groove near the bottom portion of the housing has a wider width than the remainder of the groove and a plurality of bumps are formed in the groove above the wider portion.

21. The device according to claim 20, wherein the bumps formed near the bottom of the housing are configured to secured the container in a retracted position so that the container is secured within the housing.

22. The device according to claim 7, further comprising a securing device removably attached to the bottom portion of the housing to prevent the containers from sliding out of the housing inadvertently.

23. The device according to claim 22, wherein the securing device is attached to a bottom portion of the movement control device.

24. The device according to claim 23, wherein a bottom surface of the securing device is substantially coplanar with a bottom surface of the housing and a bottom surface of the containers when the containers are stored in the retracted position in the housing.

25. The device according to claim 1, wherein at least a part of a side surface of at least one of the containers is exposed when the container is in the retracted position.

26. The device according to claim 1, wherein the side surfaces of the housing are tapered, with a narrowest width of the housing due to the tapered sides is located in substantially a center portion of the housing.

27. The device according to claim 1, wherein at least one of the at least one containers contains a cosmetic product

28. The device according to claim 27, wherein said container includes a lip make-up product.

29. The device according to claim 25, wherein each of the at least one containers has a different color.

30. A device for containing a product, comprising:
a housing having a first container mounting site; and
a first container mountable on said first container mounting site,
wherein said device can be shifted between a first operational state and a second operational state,
wherein in said first operational state, said container is movable relative to said housing between an extended position and a retracted position and wherein said container is locked to said housing such that the container is not dislocated or separated from said housing, and wherein in said second operational state said container is removable from said housing.

31. The device according to claim 30, wherein the housing has a length and the container has a lid, wherein when the lid is within the length of the housing when in the retracted position and is extended outside of the length when the container is in the extended position.

32. The device according to claim 30, wherein a direction of removal of the container from the housing is in an opposite direction from a direction of movement of the container from the retracted position to the extended position.

33. The device according to claim 30, further comprising
a second container mounting site; and
a second container mountable on said second container mounting site.

34. The device according to claim 33, wherein at least a part of a side surface of at least one of the containers is exposed when the container is in the retracted position.

35. The device according to claim 34, wherein at least one side of the housing is tapered in a longitudinal direction of the housing with a narrowest portion of the tapered area being located in substantially a center portion of the housing.

36. The device according to claim 31, wherein the first and second containers are a different color.

37. The device according to claim 31, wherein the containers are a different color from the housing.

38. The device according to claim 33, wherein a groove is formed within the housing substantially parallel to a direction of movement of the container within the housing, and wherein each container includes a projection to engage the groove.

39. The device according to claim 38, wherein a width of the groove remains substantially constant along a length of the groove.

40. The device according to claim 38, further comprising a movement control device formed in the housing and including a flexible track formed by the groove and slits extending substantially parallel to the groove, wherein the flexible track is configured to contact the projection as the projection slides within the groove and move in a direction substantially transverse to a longitudinal direction of the groove.

41. The device according to claim 40, wherein a plurality of bumps are formed on each side of the flexible track that allow the projection to slide there between and wherein an audible noise is generated when the projection slides in between the bumps.

42. The device according to claim 41, wherein a stopping portion is formed at a top portion of the groove to prevent the projection from further movement towards a top portion of the housing, wherein the stopping portion in formed from a sufficiently narrow portion of the groove to prevent the projection from sliding any further in the groove.

43. The device according to claim 30, wherein when the container is secured in the extended position, a cap formed on the container for providing access to contents of the container extends beyond a top surface of the housing.

44. The device according to claim 41, wherein bumps formed near a bottom of the housing are configured to secured the container in a retracted position within the housing.

45. The device according to claim 33, further comprising a securing device removably attached to a bottom portion of the housing to prevent the containers from sliding out of the housing inadvertently.

46. The device according to claim 33, wherein the first and second containers can be locked in at least one of the extended position, the retracted position, and any position in between, when the first and second containers are in the first operational state.

47. The device according to claim 30, wherein the product is a cosmetic product.

48. The device according to claim 46, wherein the product is a lip product.
